(19) United States
(12) Patent Application Publication
(10) Pub. No.: US 2006/0075481 A1
(43) Pub. Date: Apr. 6, 2006

(54) System, method and device for intrusion prevention

(76) Inventors: Alan D. Ross, Shingle Springs, CA (US); Michael Gutman, Zichron-Yaacov (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/950,496

(22) Filed: Sep. 28, 2004

(51) Int. Cl. G06F 15/16

(52) U.S. Cl. 726/13

(57) ABSTRACT

Embodiments of the present invention provide a method, apparatus and system for intrusion prevention. The method according to some exemplary embodiments of the invention may include determining whether a current packet associated with a host is a malicious packet based on at least one predetermined, host-specific, inspection rule related to the host. Other embodiments are described and claimed.

### BACKGROUND OF THE INVENTION

Conventional intrusion prevention methods, e.g., of a malicious packet, may implement a Network Intrusion Detection (NID) system adapted to monitor traffic on a network, e.g., in accordance with a set of predetermined generic inspection rules. A management console may be associated with the NID and with one or more communication systems. The management console may be alerted by the NID, e.g., when a packet is determined by the NID to be a malicious packet. The management console may alert the communication stations regarding the detected malicious packet, e.g., after verifying the packet is actually malicious.

Unfortunately, in conventional systems, some of the stations may be exposed to “infection” by the malicious packet, e.g., during the time period between determining that the packet may be malicious and notifying the stations by the management console.

Furthermore, such detection methods may result in a large number of false alerts since generic inspection rules are inherently broad, e.g., in order to provide sufficient protection to all the different communication stations.

Other conventional methods for intrusion prevention may implement software customized for specific applications, e.g., E-mail applications or specific anti-virus applications. Such software may only protect the specific applications from intrusion, while other applications remain unprotected. Furthermore, such software may be exposed to malicious software attacks, which may alter, tamper with, and/or “shutoff” the software protection, e.g., during a power-up operation mode of the host.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic diagram of a communication system in accordance with some exemplary embodiments of the present invention;

FIG. 2 is a schematic illustration of a policy enforcement point in accordance with some exemplary embodiments of the invention;

FIG. 3 is a schematic diagram of a Policy-Enforcement-Point (PEP) management system in accordance with some exemplary embodiments of the present invention; and

FIG. 4 is a schematic flow-chart illustration of a method for intrusion prevention in accordance with some exemplary embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that the present invention may be used in a variety of applications. Although the present invention is not limited in this respect, the circuits and techniques disclosed herein may be used in many apparatuses such as units of a communication system, for example, a wired communication system, a wireless communication system, a digital communication system, a satellite communication system and the like.

Devices, systems and methods incorporating aspects of embodiments of the invention are also suitable for computer communication network applications, for example, intranet and Internet applications. Embodiments of the invention may be implemented in conjunction with hardware and/or software adapted to interact with a computer communication network, for example, a Local Area Network (LAN) communication system, a Wireless Local Area Network (WLAN) communication system, or a global communication network, for example, the Internet.

Part of the discussion herein may relate, for exemplary purposes, to inspecting a packet received over a communication channel, e.g., a wired communication channel or a wireless communication channel, or a packet intended for transmission over the communication channel. However, embodiments of the invention are not limited in this regard, and may include, for example, inspecting a signal, a block, a data portion, a data sequence, a frame, a data signal, a preamble, a signal field, a content, an item, a message, a protection frame, or the like.

It will be appreciated that the term “malicious packet” as used herein may refer to a “virus” packet, an “intruding” packet, an “attacking” packet, a “Trojan horse” packet, a “worm” packet, a “spy” packet, a “data mining” packet, a “suspicious” packet, a “mail bomb” and/or any other packet at least partially including a “virus” or any other prohibited, un-secure, harmful, illegal, damaging, infecting, suspicious and/or otherwise unauthorized code, header, payload, script, program, sequence, string, signature, pattern, information and/or any other content.

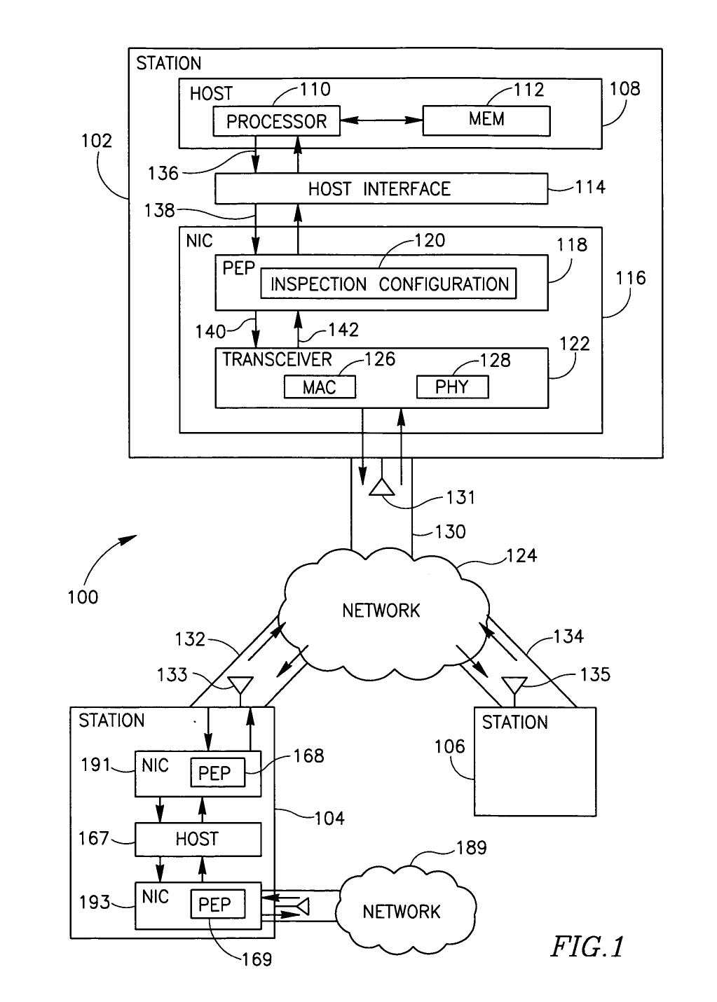

Reference is made to FIG. 1, which schematically illustrates a communication system 100 in accordance with an embodiment of the present invention.

According to some exemplary embodiments of the invention, communication system 100 may include at least one communication station, e.g., stations 102, 104 and 106, able to communicate over a network 124, e.g., using communication channels 130, 132 and 134, respectively. In some embodiments, stations 102, 104 and/or 106 may transmit and/or receive one or more packets over network 124. The packets may include data, control messages, network information, and the like.

According to some exemplary embodiments of the invention, system 100 may include a wireless communication system and network 124 may include a wireless network. According to these exemplary embodiments, stations 102, 104 and/or 106 may include one or more antennas 131, 133 and/or 135, respectively, for transmitting and/or receiving packets, e.g., over wireless network 124. Although the scope of the present invention is not limited in this respect, types of antennae that may be used for antennas 131, 133 and/or 135 may include but are not limited to an internal antenna, a dipole antenna, an onmi-directional antenna, a monopole antenna, an end fed antenna, a circularly polarized antenna, a micro-strip antenna, a diversity antenna and the like.

According to other embodiments of the invention, system 100 may include a wired communication system and network 124 may include a wired network, e.g., as known in the art. Accordingly, one or more of stations 102, 104 and 106 may not include antennas 131, 133 and/or 135, respectively, and/or may include any other suitable unit, device or module, e.g., implemented by hardware and/or software as known in the art, for communicating over wired network 124.

According to some exemplary embodiments of the invention, one or more of stations 102, 104 and 106 may include a host 108 associated with a communication module, e.g., a Network Interface Card (NIC) 116, for example, via a host interface 114, as are described in detail below.

In some embodiments, host. 108 may include or may be, for example, a computing platform, e.g., a personal computer, a desktop computer, a mobile computer, a laptop computer, a notebook computer, a terminal, a workstation, a server computer, a Personal Digital Assistant (PDA) device, a tablet computer, a network device, or other suitable computing device.

According to some exemplary embodiments of the invention, host 108 may include a processor 110, which may be associated with a memory 112. Processor 110 may include, for example, a Central Processing Unit (CPU), a Digital Signal Processor (DSP), a microprocessor, a host processor, a plurality of processors, a controller, a chip, a microchip, or any other suitable multi-purpose or specific processor or controller. Processor 110 may be able to generate signals 136 including packets intended for transmission via communication channel 130. Host interface 114 may include any suitable hardware and/or circuitry, e.g., as known in the art, for generating signals 138 including the packets of signals 136 in a format suitable for NIC 116.

According to exemplary embodiments of the invention, NIC 116 may include a Policy Enforcement Point (PEP) 118 associated with host interface 114, and a transceiver associated with PEP 118, as are described in detail below.

According to some exemplary embodiments of the invention, transceiver 122 may include any suitable circuitry, software and/or hardware for transmitting a packet, e.g., provided by PEP 118 via signals 140, and/or for transferring to PEP 118, e.g., via signals 142, one or more packets received from network 124. For example, module 122 may include a Media Access Control module 126 and/or a Physical Layer (PHY) 128, as are known in the art. In some embodiments, transceiver 122 may be implemented, for example, using separate units, e.g., using a receiver and a transmitter.

It will be appreciated that the term “current packet” as used herein may refer to a currently inspected packet, e.g., a currently received packet of signals 142, or a packet currently intended for transmission, e.g., a packet of signals 138. The term “previous packet” as used herein may refer to a previously inspected packet, e.g., a previously received packet or a packet previously intended for transmission whether actually transmitted or not transmitted.

According to some exemplary embodiments of the invention, PEP 118 may include an inspection configuration able to determine whether a current packet is a malicious packet, for example, based on at least one predetermined, e.g., host-specific, inspection rule related to host 108 and/or based on information related to at least one previous packet, as described in detail below.

Although some embodiments of the invention are described above with reference to a system, e.g., system 100 including a station, e.g., station 102, adapted to communicate over one network, e.g., a wireless or wired network 124, it will be appreciated by those skilled in the art that according to other embodiments of the invention the communication system may include more than one network, e.g., a wired network and a wireless network, and one or more stations adapted to communicate both over both the wireless network and the wired network. For example, system 100 may include an additional network 189, e.g., a wireless network, and network 124 may include a wired network. Station 104 may include, for example, a host 167 associated with a first NIC 191 adapted to communicate over wired network 124, and a second NIC 193 adapted to communicate over wireless network 189. NIC 191 may include a PEP 168 and/or NIC 169 may include a PEP 169, e.g., as described below.

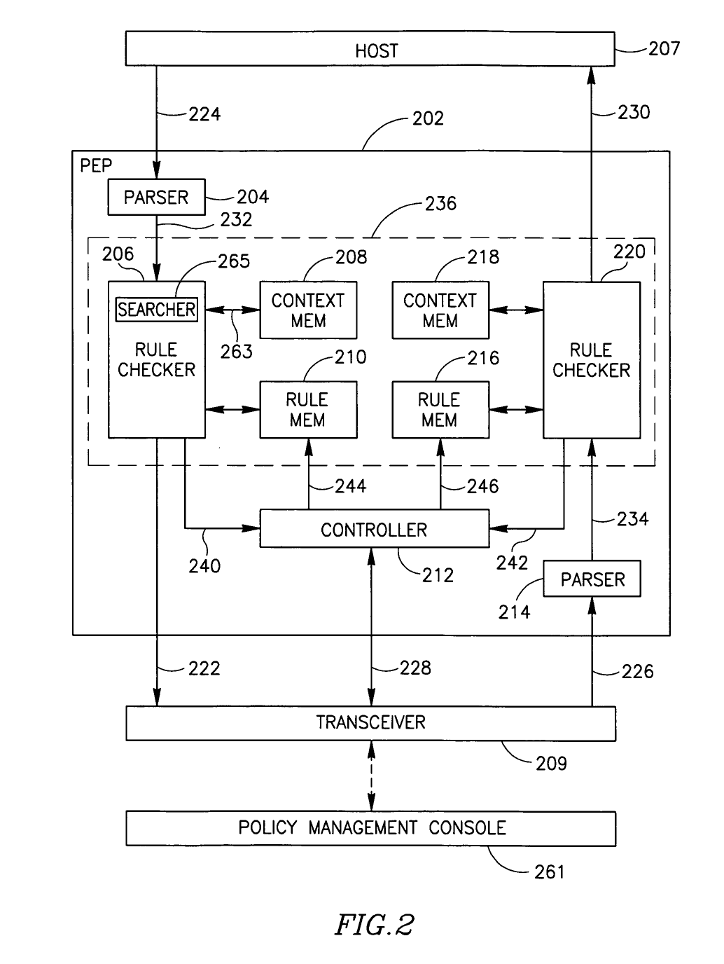

Reference is made to FIG. 2, which schematically illustrates a PEP 202 in accordance with some exemplary embodiments of the invention. Although the invention is not limited in this respect, PEP 200 may be used to perform the functionality of PEP 118, PEP 168 and/or PEP 169 (FIG. 1).

According to some exemplary embodiments of the invention, PEP 202 may include a first parser 204, a second parser 214, a controller 212 and an inspection configuration 236, as are described in detail below.

According to some exemplary embodiments of the invention, parser 204 may include any suitable hardware, circuitry and/or software, e.g., as known in the art, to separate a packet intended for transmission, e.g., a packet generated by a host 207 and provided to parser 204 via signal 224, into one or more fields, e.g., a data (“payload”) field, a command field, a header field and/or any other field. Parser 214 may include any suitable hardware, circuitry and/or software, e.g., as known in the art, to separate a received packet, e.g., received from transceiver 209 via signal 226, into one or more fields, e.g., a data (payload) field, a command field, a header field and/or any other field.

According to some exemplary embodiments of the invention, inspection configuration 236 may be able to fetch from parser 204, e.g., via signals 232, one or more fields of the packet intended for transmission, and determine whether the packet intended for transmission is a malicious packet based on at least one predetermined inspection rule related to host 207, and/or based on context information related to at least one previous packet, as described in detail below.

According to some exemplary embodiments of the invention, inspection configuration 236 may provide the packet intended for transmission to transceiver 209, e.g., via signals 222, for example, if the packet intended for transmission is determined to be a non-malicious packet.

According to some exemplary embodiments of the invention, inspection configuration 236 may prevent the transmission of the packet intended for transmission, e.g., by not providing the packet to transceiver 209 (“dropping the current packet” or “blocking the current packet”), for example, if the packet intended for transmission is determined to be a malicious packet. Inspection configuration 236 may also be able to provide controller 212 with information regarding the malicious packet, e.g., via signals 240, as described in detail below.

Additionally or alternatively, inspection configuration 236 may be able to fetch from parser 214 one or more portions of the received packet, e.g., via signals 234. Inspection configuration 236 may determine whether the received packet is a malicious packet, based on at least one predetermined inspection rule related to host 207 and/or based on context information related to at least one previous packet. Inspection configuration 236 may provide the received packet to host 207, e.g., via signals 230, if the received packet is determined to be a non-malicious packet. Inspection configuration 236 may not transfer the received packet to host 207, for example, if the received packet is determined to be a malicious packet. Inspection configuration 236 may also be able to provide controller 212 with information regarding the malicious packet, e.g., via signals 242.

According to some exemplary embodiments of the invention, controller 212 may include, for example, an embedded processor, e.g., a CPU, a microprocessor, a plurality of processors, a chip, a microchip, or any other suitable multi-purpose or specific processor able to inform (“alert”) a policy management console 261, e.g., using signals 228, of the malicious packet information received by signals 240 and/or signals 242, as described below. Controller 212 may also be able to update one or more of the inspection rules implemented by inspection configuration 236, e.g., in accordance with instructions received from policy management console 261, e.g., via signals 228, as described below.

According to some exemplary embodiments of the invention, inspection configuration 236 may include a first rule checker 206, a first context memory 208, a first rule memory 210, a second rule checker 220, a second context memory 218, and a second rule memory 216, as are described below.

According to some exemplary embodiments of the invention, one or more of memory 208, memory 210, memory 218 and/or memory 216 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory.

According to some exemplary embodiments of the invention, rule memory 210 and/or rule memory 216 may store one or more inspection rules for inspecting a current packet according to any suitable detection method. For example, at least some of the inspection rules may include inspection rules of a signature detection method, e.g., the SNORT™ detection method as is known in the art. Such inspection rules may include, for example, information of a predetermined string, pattern, code or sequence to be searched, a location and/or a field in the current packet in which the predetermined string, pattern, code or sequence is to be searched, and/or any other desired information.

According to some exemplary embodiments of the invention, rule memory 210 and/or rule memory 216 may additionally or alternatively include one or more inspection rules related to host 207. Such inspection rules may be host-specific and may include, for example, inspection rules specifically related to one or more applications, e.g., mail applications, internet application or any other applications, executed or intended to be executed by host 207, one or more user profiles of a user using or intended to use host 207, the location of host 207, the computing capacity of host 207, an Operating System (O/S) implemented by host 108, e.g., the Windows O/S or the Linux O/S, and/or any other desired inspection rules related to one or more aspects and/or characteristics of host 207.

A fragmented attack may include a code, sequence, pattern, string, or any other malicious content fragmented over two or more packets either according to a predetermined sequence or out of sequence. For example, a fragmented attack may include a first packet including, e.g., at the end of the first packet, a first portion of a malicious code, and a second packet including, e.g., at the beginning of the packet, a second portion of the malicious code.

According to some exemplary embodiments of the invention, it may be desired to inspect the current packet according to the context of the current packet, for example, in relation to one or more previous packets, e.g., as described below.

According to some exemplary embodiments of the invention, context memory 208 and/or context memory 218 may store context information relating to one or more previous packets. Such context information may include, for example, information relating to the content of one or more previous packets, specific sequences of previous packets, the identity of the source (“the sender”) or the destination (“the receiver”) of one or more previous packets, e.g., the identity of a Transmission Control Protocol (TCP) connection, and/or any other suitable information regarding one or more previous packets.

According to some exemplary embodiments of the invention, rule checker 206 may include any suitable hardware, software, and/or circuitry able to fetch from parser 204 at least some fields of the packet intended for transmission, e.g., via signals 232. Rule checker 206 may determine whether the packet intended for transmission is a malicious packet, e.g., based on one or more of the inspection rules stored by rule memory 210, and/or based on the context information of context memory 208, e.g., as described below.

It will be appreciated that the term “malicious sequence” as used herein may refer to a string, a pattern, a data sequence, a code, or any other content in accordance with one or more of the inspection rules. The term “partial malicious sequence” as used herein may refer to a part, a portion or a fragment of a malicious sequence.

According to exemplary embodiments of the invention, rule checker 206 may include a searcher 265, e.g., as is known in the art, able to search through one or more of the fields, e.g., the payload, of the packet intended for transmission for at least part of one or more malicious sequences, e.g., as fetched from rule memory 210.

According to some exemplary embodiments of the invention, at least some of the inspection rules may be stored in memory 210 in the form of a table. For example, at least one entry of the table may include a first field including a predetermined sequence of bits, e.g., 16-bytes, relating to a malicious sequence, and a second field including a predetermined sequence of bits, e.g., four bits, having a value n relating to a length of the malicious sequence that is to be searched. Accordingly, searcher 265 may be able, for example, to search through the packet intended for transmission for a sequence containing n+1 Least Significant Bytes (LSBs) of the first field of the inspection rule.

According to some exemplary embodiments of the invention, searcher 265 may be able to search through the payload of the packet intended for transmission for the entire malicious string, e.g., including n+1 bytes. Searcher 265 may also able to search, e.g., through the n LSBs and n Most Significant Bits (MSBs) of the payload, for one or more partial malicious sequences derived from the malicious sequence and having a length equal to or longer than a predetermined minimum length m. For example, when inspecting first and second successive packets, searcher 265 may search through the first and second packets for the entire malicious string, e.g., including n+1 bits. Searcher 265 may also compare k LSBs of the malicious sequence with k MSBs of the first packet, wherein k=n, (n−1), (n−2), . . . , (m−1), m. Searcher 265 may also compare j MSBs of the malicious string with j LSBs of the second packet, wherein j=m, m+1, n+2, . . . , (n−1), n. For example, if the length of the payload of the packet intended for transmission is 256 bytes, the length of the malicious sequence is 16 bytes, and m=2 bytes, then searcher 265 may search, e.g., through the entire 256 bytes of the payload for the entire 16-byte malicious sequence. Searcher 265 may also compare the last 15, 14, 13 . . . , 3, 2 bytes of the payload with the first 15, 14, 13, . . . , 3, 2 bytes of the malicious sequence, respectively.

According to exemplary embodiments of the invention, the packet intended for transmission may be determined to be a malicious packet, e.g., if the packet intended for transmission includes one or more of the malicious sequences.

According to exemplary embodiments of the invention, rule checker 206 may also be able to provide context memory 208 with context information related to the packet intended for transmission. For example, if only a partial malicious sequence is detected in the packet intended for transmission, then the context information may include information relating to the detected partial malicious sequence, e.g., the length of the detected partial malicious sequence, the location of the detected partial malicious sequence within the packet intended for transmission and/or any other desired information related to the packet intended for transmission and/or the partial malicious sequence.

According to some exemplary embodiments of the invention, rule checker 206 may also be able to determine whether the packet intended for transmission is a malicious packet based on context information stored in memory 208 relating to one or more previous packets. For example, rule checker 206 may compare one or more attributes of the packet intended for transmission with one or more corresponding attributes of previous packets, e.g., using the context information of memory 208. Rule checker 206 may determine that the packet intended for transmission is a malicious packet if, for example, a first partial malicious sequence is detected in the packet intended for transmission and the context information relates to a second partial malicious sequence of a previous packet, wherein the first and second partial malicious sequences relate to a single malicious sequence and the packet intended for transmission and previous packet have similar attributes, e.g., the two packets are addressed to the same receiver.

According to exemplary embodiments of the invention, rule checker 206 may provide transceiver 209 with the packet intended for transmission, e.g., via signals 222, for example, if the packet intended for transmission is determined to be a non-malicious packet. Rule checker 206 may drop or block the packet intended for transmission, e.g., if the packet intended for transmission is determined to be a malicious packet. Rule checker 206 may also be able to provide controller 212 with information regarding the malicious packet, e.g., via signals 240. Such information may include, for example, information related to the payload of the malicious packet, the destination of the malicious packet, and/or any other information related to the malicious packet.

According to some exemplary embodiments of the invention, rule checker 220 may include any suitable hardware, software, and/or circuitry able to determine whether a packet received via signals 226 is a malicious packet, e.g., based on one or more of the inspection rules stored in rule memory 216, and/or based on the context information of context memory 218, e.g., in analogy to the above description relating to rule checker 206.

According to exemplary embodiments of the invention, rule checker 220 may provide host 207 with the received packet, e.g., via signals 230, for example, if the received packet is determined to be a non-malicious packet. Rule checker 220 may drop or block the received packet, e.g., if the received packet is determined to be a malicious packet. Rule checker 220 may also be able to provide controller 212 with information regarding the malicious packet, e.g., via signals 242. Such information may include, for example, information related to the payload of the malicious packet, the source of the malicious packet, and/or any other information related to the malicious packet.

Some aspects of the invention are described herein in the context of an exemplary embodiment of a PEP, e.g., PEP 202, including two or more separate parsers, e.g., parsers 204 and 214, two or more separate rule checkers, e.g., rule checkers 206 and 220, two or more separate context memories, e.g., memories 208 and 218, and/or two or more separate rule memories, e.g., rule memories 210 and 216. However, it will be appreciated by those skilled in the art that, according to other embodiments of the invention, any other combination of integral or separate units may also be used to provide the desired functionality, for example, the PEP may include a single parser, a single rule checker, a single context memory and/or a single rule memory.

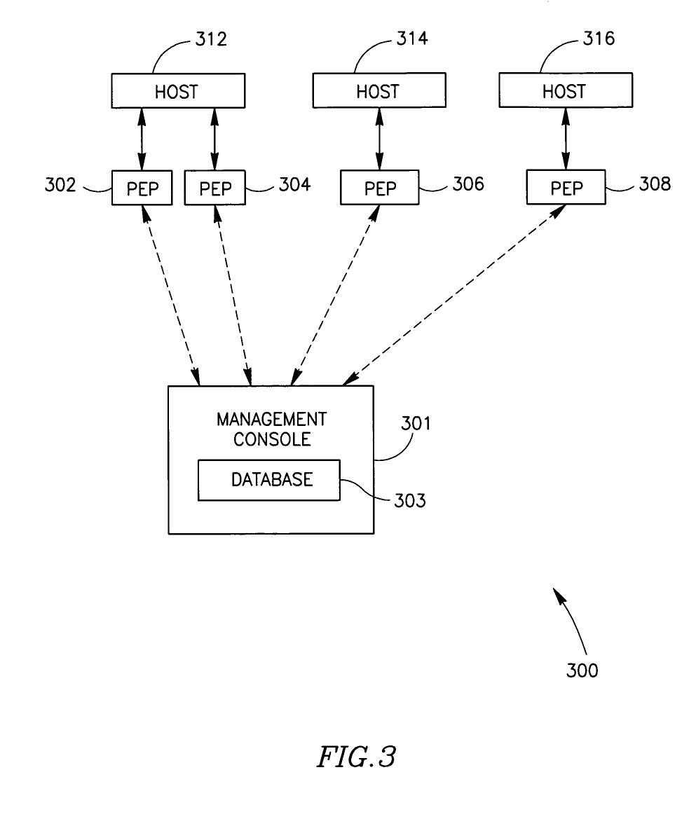

Reference is made to FIG. 3, which schematically illustrates a PEP management system 300 according to some exemplary embodiments of the invention.

According to some exemplary embodiments of the invention, system 300 may include a policy management console 301 able to communicate, e.g., via a wired and/or wireless communication channel, with one or more PEPs, e.g., PEPs 302, 304, 306 and 308, associated with one or more hosts, e.g., hosts 312, 314 and 316, as described below. Console 301 may be associated with a database 303 able to store one or more inspection rules.

According to some exemplary embodiments of the invention, the inspection rules, e.g., of PEPs 302, 304, 306 and/or 308, may be updated for example, at one or more predetermined time periods, e.g., including a time period corresponding to a power-up mode of hosts 312, 314 and/or 316. For example, PEP 302 and/or 306 may attempt to communicate with console 301, e.g., during a time period corresponding to the power-up mode of host 312. The inspection rules of PEP 302 and/or PEP 304 may be updated by inspection rules of database 303, for example, in accordance with one or more predetermined attributes of host 312, e.g., if communication with console 303 is available. PEP 302 and/or PEP 304 may use default inspection rules, e.g., previously stored inspection rules, if communication with console 301 is not available.

According to some exemplary embodiments of the invention, PEPs 302, 304, 306 and/or 308 may alert console 301 of any malicious packets received or intended for transmission by PEPs 302, 304, 306 and/or 308, e.g., as described above.

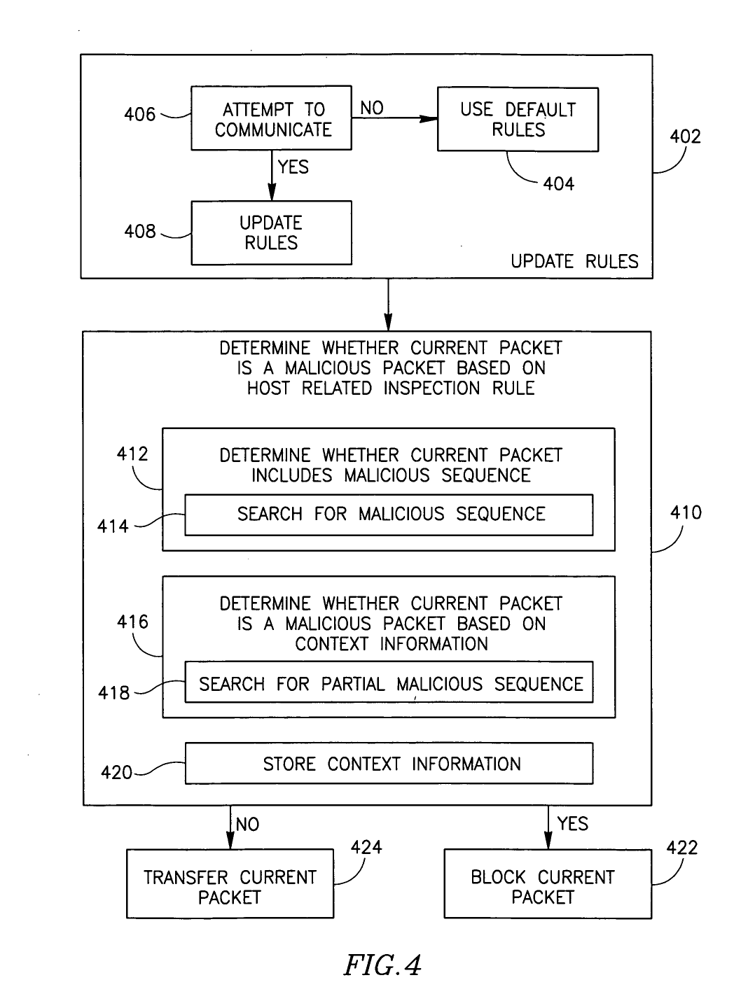

Reference is made to FIG. 4, which schematically illustrates a method for intrusion prevention according to some exemplary embodiments of the invention.

As indicated at block 410, the method may include determining whether a current packet provided by a host or intended to be provided to the host is a malicious packet based on at least one predetermined inspection rule related to the host, e.g., as described above.

As indicated at block 412, determining whether the current packet is a malicious packet may include determining whether the current packet includes a predetermined malicious sequence. For example, as indicated at block 414, the method may include searching for the malicious sequence, as described above.

As indicated at block 416, determining whether the current packet is a malicious packet may include determining whether the current packet is a malicious packet based on context information related to one or more previous packets, as described above. For example, as indicated at block 418, the method may include searching for a partial malicious sequence, as described above. The method may also include storing the context information, as indicated at block 420.

As indicated at block 422, the method may include blocking or dropping the current packet, e.g., if the current packet is determined to be a malicious packet.

As indicated at block 424, the method may include transferring the current packet, e.g., to the host or to a transmitter, if the current packet is determined to be a non-malicious packet.

As indicated at block 402, the method may include updating the inspection rules, for example, during one or more predetermined time periods, e.g., including a time period corresponding to a power-up mode of the host. For example, the method may include attempting to communicate with a managing console, e.g., during a time period corresponding to the power-up mode of the host, as indicated at block 406. The method may include updating the inspection rules with inspection rules received from the managing console, e.g., if communication with the managing console is available, as indicated at block 408. The method may include using default inspection rules, e.g., previously stored inspection rules, if communication with the managing console is not available, as indicated at block 404.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. An apparatus comprising:
an inspection configuration able to determine whether a current packet associated with a host is a malicious packet, based on at least one predetermined, host-specific, inspection rule.

2. The apparatus of claim 1, wherein said current packet comprises a packet provided by said host.

3. The apparatus of claim 1, wherein said current packet comprises a packet intended to be provided to said host.

4. The apparatus of claim 1, wherein said inspection configuration comprises a rule memory able to store said at least one inspection rule.

5. The apparatus of claim 1, wherein said inspection configuration comprises a rule checker able to determine whether said current packet includes at least a portion of a predetermined malicious sequence corresponding to said inspection rule.

6. The apparatus of claim 5, wherein said rule checker comprises a searcher able to search at least part of said current packet for at least a portion of said malicious sequence.

7. The apparatus of claim 5, wherein said rule checker is able to block said current packet if said current packet is determined to be a malicious packet.

8. The apparatus of claim 5, wherein said inspection configuration is able to inspect said current packet based on context information related to at least one previous packet.

9. The apparatus of claim 8, wherein said inspection configuration comprises a context memory able to store said context information.

10. The apparatus of claim 8, wherein said inspection configuration comprises a searcher able to search at least part of said current packet for one or more at least partial malicious sequences based on said context information.

11. The apparatus of claim 1 comprising at least one parser to separate one or more fields of said current packet.

12. The apparatus of claim 1 comprising a controller able to update one or more of said inspection rules.

13. The apparatus of claim 12, wherein said controller is able to provide to a managing console an alert regarding one or more malicious packets detected by said inspection configuration.

14. The apparatus of claim 13, wherein said controller is able to communicate with said managing console to receive said one or more inspection rules.

15. The apparatus of claim 14, wherein said controller is able to communicate with said managing console during a time period corresponding to a power-up mode of said host.

16. A method comprising:
determining whether a current packet associated with a host is a malicious packet, based on at least one predetermined, host-specific, inspection rule.

17. The method of claim 16, wherein determining whether said current packet is a malicious packet comprises determining whether said current packet includes at least a portion of a predetermined malicious sequence corresponding to said inspection rule.

18. The method of claim 17, wherein determining whether said current packet includes at least a portion of said predetermined malicious sequence comprises searching at least part of said current packet for at least a portion of said malicious sequence.

19. The method of claim 16 comprising blocking said current packet if said current packet is determined to be a malicious packet.

20. The method of claim 16, wherein determining whether said current packet is a malicious packet comprises determining whether said current packet is a malicious packet based on context information related to at least one previous packet.

21. The method of claim 20 comprising storing said context information.

22. The method of claim 20, wherein determining whether said current packet is a malicious packet based on said context information comprises searching at least part of said current packet for one or more at least partial malicious sequences based on said context information.

23. The method of claim 16 comprising updating one or more of said inspection rules.

24. The method of claim 23, wherein updating one or more of said inspection rules comprises receiving updated instruction rules from a managing console.

25. The method of claim 24, wherein receiving updated instruction rules from a managing console comprises receiving updated instruction rules from a managing console at one or more predetermined time periods.

26. The method of claim 25, wherein said one or more time periods comprise a time period corresponding to a power-up mode of said host.

27. A system comprising:
a communication device comprising:
a transmitter/receiver to transmit/receive a current packet associated with a host; and
an inspection configuration able to determine whether said current packet is a malicious packet based on at least one predetermined, host-specific, inspection rule.

28. The system of claim 27 comprising another communication device able to receive one or more packets transmitted by said transmitter/receiver.

29. The system of claim 27, wherein said inspection configuration comprises a rule memory able to store said at least one inspection rule.

30. The system of claim 27, wherein said inspection configuration comprises a rule checker able to determine whether said current packet includes at least a portion of a predetermined malicious sequence corresponding to said inspection rule.

31. The system of claim 27 comprising at least one parser to separate one or more fields of said current packet.

32. The system of claim 27 comprising a controller able to update one or more of said inspection rules.

33. A program storage device having instructions readable by a machine that when executed by the machine result in:
determining whether a current packet associated with a host is a malicious packet, based on at least one predetermined, host-specific, inspection rule.

34. The program storage device of claim 33, wherein determining whether said current packet is a malicious packet comprises determining whether said current packet includes at least a portion of a predetermined malicious sequence corresponding to said inspection rule.

35. The program storage device of claim 33, wherein said instructions result in blocking said current packet if said current packet is determined to be a malicious packet.

36. The program storage device of claim 33, wherein determining whether said current packet is a malicious packet comprises determining whether said current packet is a malicious packet based on context information related to at least one previous packet.
